(19) United States
(12) Patent Application Publication
(10) Pub. No.: US 2025/0358599 A1
(43) Pub. Date: Nov. 20, 2025

(54) ENHANCED DUAL-MODE SIGNALING DEVICE

(71) Applicant: AIRBORNE OUTFITTERS, LLC, Findlay, OH (US)

(72) Inventors: Jason Brett Evatt, Findlay, OH (US); Wesley R. Bonin, Hallsville, TX (US); Kenneth Fritsch, Arnold, MD (US); William Carl Templin, Findlay, OH (US)

(21) Appl. No.: 19/208,130

(22) Filed: May 14, 2025

Related U.S. Application Data
(60) Provisional application No. 63/647,233, filed on May 14, 2024.

(51) Int. Cl. H04W 4/90; H04W 4/02

(52) U.S. Cl. CPC H04W 4/90; H04W 4/02

(57) ABSTRACT

A dual-function emergency locator device includes a main body housing both passive and active radio signaling components. The passive component includes a meta surface configured to passively reflect specific radio frequencies, while the active component includes a dipole antenna for transmitting and receiving radio signals. The device incorporates advanced sensors, edge processing capabilities, and automated activation features based on programmable thresholds. The main body includes a modular payload compartment that can be configured as a drawer, drop-out container, or hinged compartment for storing emergency supplies. A system for emergency location and communication includes remote transmitters and receivers that can distinguish between passive reflected signals and active transmitted signals from the device. A processing unit analyzes the signals to determine device location and identity, even in GPS-denied environments.

### CROSS-REFERENCE TO RELATED APPLICATIONS

This application claims the benefit of U.S. Provisional Application No. 63/647,233, filed on May 14, 2024. The entire disclosure of the above application is incorporated herein by reference.

### FIELD

The present technology relates to signaling devices and systems for emergency location and identification, and, more particularly, to dual-mode devices incorporating both active radio transmission capabilities and passive frequency selective surfaces for enhanced detection and communication in various operational environments.

### INTRODUCTION

This section provides background information related to the present disclosure which is not necessarily prior art.

Emergency and operational signaling devices, such as flares, beacons, and radio frequency (RF) transmitters, can be used to indicate location and identity in various scenarios, including military operations, search and rescue missions, and personal safety alerts. These devices, however, often exhibit certain limitations. For instance, flares and beacons can be visually obstructive, and their effectiveness can be dependent on weather conditions and visibility. RF transmitters can require significant power sources and can be detected and jammed by adversarial entities.

Certain signaling devices generally operate in either an active or passive mode but not both. Active devices can emit signals continuously or on demand, which consumes power and may inadvertently reveal the position to unintended parties. Passive devices, however, rely on external sources to detect their presence, which can be unreliable in environments where such sources are not guaranteed to be present or operational.

Another issue with certain signaling devices relates to a lack of integration with modern digital communication systems. Many signaling devices are standalone units with limited capability to interface with other electronic systems or networks. This can hinder adaptability and effectiveness in coordinated operations where real-time data exchange and interoperability are important.

The physical design of certain signaling devices does not lend itself well to concealment or integration with personal gear or vehicles. This can be a drawback in operations requiring stealth or in personal safety applications where the device should not attract attention when not in use. In commercial industries, isolated persons can utilize devices such as emergency locator radio beacons and the international Cospas-Sarsat program. However, these emergency locator beacons have a limited battery life and no means of reactive location transmission.

In certain military operations, personnel do not have signaling devices that include the means to both actively and reactively transmit position, navigation, and timing (PNT) information in a congested and contested spectrum space. Whether that space is GPS denied or heavily monitored by adversaries, with no means of friendly support, operators can have very limited means to communicate to command and control without being suppressed or intercepted by adversaries. In commercial industries, isolated persons can utilize devices such as emergency locator radio beacons and the international Cospas-Sarsat program. However, these emergency locator beacons relay on a limited battery life and have no means of reactive location transmission.

Military networks can enable aircrafts, ships, vehicles, and dismounted persons to exchange tactical information in near real time. However, radios needed to access these types of networks can be bulky, power consumptive, complicated to operate under pressure, and do not always communicate reliably. They also do not provide reactive low Probability of Intercept/Detection (LPI/LPE) capabilities and are as much an emergency beacon for adversaries as for allies. Furthermore, commercial emergency locator radio beacons, such as those made by ACR Electronics, are bulky, and rely on a limited battery life. Neither option (military nor commercial) provides an LPI/LPE reactive means to transmit PNT.

There is a continuing need for improved signaling devices that address these limitations. Desirably, such devices would offer dual-mode functionality, allowing for both active and passive operation, integrate seamlessly with digital communication networks, and feature designs that are both effective and discreet. These improvements would significantly enhance the utility and effectiveness of signaling devices across a wide range of applications.

### SUMMARY

In concordance with the instant disclosure, improved signaling devices that offer dual-mode functionality, allowing for both active and passive operation, integrate seamlessly with digital communication networks, and feature designs that are both effective and discreet, and which significantly enhance the utility and effectiveness of signaling devices across a wide range of applications, have surprisingly been discovered. The present technology includes articles of manufacture, systems, and processes that relate to the enhanced detection, identification, and communication of location information using meta surfaces in signaling devices.

In certain embodiments, a dual-function emergency locator device is provided that can include a rigid main body that can house both passive and active radio signaling components. The passive component can be disposed within the rigid main body and can be configured to passively reflect specific radio frequencies to enable location and identification of the device. The active component can include a dipole antenna that can be disposed within the rigid main body and can transmit and receive radio signals, allowing for direct communication capabilities while maintaining low probability of intercept characteristics.

In certain embodiments, a system for emergency location and communication is provided that can incorporate the dual-function emergency locator device along with a remote receiver and processing unit. The remote receiver can be configured to detect signals transmitted by the active radio signaling component, while the processing unit can analyze the received signals to determine the device location. This system can enhance the effectiveness of search and rescue operations by providing precise location data and reliable communication links through both active and passive signaling capabilities.

In certain embodiments, a method for locating and communicating in emergency situations is provided that can utilize the dual-function emergency locator device integrated capabilities. After deploying the device, the method can provide multiple operational pathways including: processing sensor data to monitor environmental conditions, automatically activating emergency signals based on preset thresholds, transmitting emergency signals through the active component, receiving and reflecting interrogation signals through the passive component, and processing received signals to determine location and identity. The method can enable flexible response options while maintaining reliable communication in GPS-denied or contested environments.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a block diagram of a dual-function emergency locator device that can include a rigid main body housing both passive and active radio signaling components, where the passive component can include a meta surface configured to passively reflect specific radio frequencies and the active component can include a dipole antenna configured for transmitting and receiving radio signals.

FIG. 2 shows a block diagram of a system for emergency location and communication that can include the dual-function emergency locator device, a remote receiver configured to detect signals from the device, a processing unit configured to analyze signals and determine device location, and a remote transmitter configured to send radio signals to the device.

FIG. 3 shows a flowchart illustrating a method for locating and communicating in emergency situations that can include providing the system, deploying the device, activating components and transmitting/receiving signals, and processing signals to determine device location.

FIG. 4 is a top perspective view of a dual-function emergency locator device having a rigid main body configured in a cube-shaped structure with a payload drawer shown in closed position according to one embodiment of the present disclosure.

FIG. 5 is a bottom perspective view of the dual-function emergency locator device with the payload drawer in the closed position according to one embodiment of the present disclosure.

FIG. 6 is a top perspective view of the dual-function emergency locator device with the payload drawer in an open position according to one embodiment of the present disclosure.

FIG. 7 is a bottom perspective view of the dual-function emergency locator device with the payload drawer in the open position according to one embodiment of the present disclosure.

FIG. 8 is a top perspective view of the dual-function emergency locator device showing passive and active radio signaling components disposed within the drawer in the open position and a user interface element according to one embodiment of the present disclosure.

FIG. 9 is a cross-sectional view taken along line 9-9 of FIG. 8 showing the internal components of the dual-function emergency locator according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A dual-function emergency locator device and uses thereof are provided that can enhance location and identification capabilities in various operational environments. The present technology improves communications systems, can be applied to personnel recovery and signaling systems, and can use meta surfaces for enhanced location and identification capabilities. In certain embodiments, a dual-function emergency locator device is provided that can include both active and passive radio signaling components. Use of this configuration allows the dual-function emergency locator device to operate effectively under diverse conditions, providing reliable performance whether in an active mode or a passive mode.

The dual-function emergency locator device can incorporate both active and passive radio signaling components to provide comprehensive signaling capabilities. The passive components can include meta surfaces that can be used to enhance location and identification capabilities through unique electromagnetic signatures. The meta surfaces can include one or more frequency selective surfaces (FSS), Van Atta arrays, reconfigurable intelligent surfaces, electromagnetic skins, and other electromagnetic structures. In one configuration, the meta surface can include a substantially planar substrate with a radio frequency reflection element configured to reflect specific radio frequencies, enabling identification and location of the device and user.

The passive components can provide detection capabilities without requiring continuous power consumption and can help militate against detection by adversarial entities. The passive components can be configured to reflect specific electromagnetic frequencies while allowing all other frequencies to pass through. The frequency selective surface can be tuned to operate within specific frequency ranges, such as L-band, S-band, C-band, X-band, Ku-band, K-band, and Ka-band, allowing the device to interact optimally with common search and rescue equipment. The passive component can be selectively tunable based on the end use. The device can incorporate powered reactive signaling capabilities including one or more signal modulating components, amplifiers, digital radio frequency memory (DRFM), and beam steering capabilities. These features can enhance the ability to provide distinct and directed signal responses. The passive components can be configured to provide multiple reflection peaks or a multi-radio frequency reflection pattern that can be detected by emitters/receivers to provide a barcode-like response for positive identification. The passive components can be particularly useful when the user is incapacitated or in situations where stealth is required. The passive capability can allow for identifying and locating the user with minimal risk of third-party detection. This capability can be especially valuable in GPS-denied environments or where certain other communication systems may be unreliable or compromised.

The active components can include a dipole antenna configured for transmitting and receiving radio signals. The antenna can be connected to a coaxial cable for signal transmission and can be embedded within the device to conceal the presence of the antenna. The dipole antenna can be attached to a coaxial cable coaxial connector. Brass heat-set inserts can be inserted into the dipole elements such that a pigtailed coax cable can be soldered directly to the dipole elements. The attached coax cable can be connected to various emergency locator beacon embedded modules such as a COSPAS-SARSAT 406 MHz PCB Card from Musson Marine or an MRB-5007-1G All-in-One Cospas-Sarsat Embedded Module from Syrlinks. The PCB board can utilize the International COSPAS-SARSAT frequency of 406 MHz. Other radio modules can be used depending on mission set or operational need. The antenna dipole elements can be configured to certain frequencies as needed, or a small LCR matching circuit can be used to match antenna impedance to a selected or predetermined frequency.

The device can incorporate one or more sensors based on specific end-user requirements and operational needs. These sensors can include wearable biofeedback sensors, barometric pressure sensors, water pressure sensors, acoustic sensors, SIGINT sensors, optical sensors, environmental sensors, chemical detection sensors, and location and targeting sensors. The selection and integration of sensors can be customized to meet mission-specific requirements and user needs. In certain embodiments, the device can be modular. The user can select, add, and remove sensors to the device as needed.

The device can be configured with advanced processing capabilities to receive, parse, and transmit data from connected sensors through an edge processing unit. This processing capability can enable local analysis of sensor inputs and autonomous decision-making based on collected data. The edge processing unit can be configured to handle multiple sensor inputs simultaneously while maintaining efficient power consumption. The edge processing unit can be configured to interface with multiple sensor types through a control circuit that can execute code using multiple processing cores at different stages of execution. The control circuit can independently execute two or more instruction threads using the same process resources to speed computational processes for functions like machine learning and artificial intelligence.

The system can be programmed with customizable activation parameters and preset thresholds that can trigger automated signal transmission. The parameters can be based on various environmental conditions, physiological measurements, chemical detection thresholds, pressure variations, acoustic signatures, or other sensor-specific criteria. The thresholds can be adjusted and modified based on specific operational requirements or changing mission parameters. The edge processing unit, such as an NVIDIA Orin Nano™, can be configured to process and analyze multiple data streams simultaneously from various sensor inputs. The processing unit can be configured to utilize these data streams to determine when preset thresholds or specific criteria have been met. The control circuit can be configured to generate, via a transceiver, an RF signal when a transmit signal based is received based on the analyzed sensor data.

When sensor readings meet or exceed preset thresholds, the device can automatically initiate signal transmission through active components. This automated response capability can be particularly valuable in situations where manual activation may not be possible or practical. The device can be configured to transmit different types of signals or messages depending on which sensor threshold has been triggered. The edge processing capabilities can enable local data processing and autonomous operation, with the ability to handle sensor data through both preset parameters and programmed activation criteria. The system can be configured to process these multiple data streams while maintaining efficient power consumption and can be integrated with either existing communication networks or operate as a standalone system. The sensor data can be integrated with device communication capabilities, allowing transmission of both sensor readings and automated alerts through either existing communication networks or as a standalone system. This integration can enable real-time monitoring in response to changing environmental or physiological conditions.

The passive components and the active components can be disposed on or in a rigid main body. The rigid main body of the dual-function emergency locator device can be constructed to be durable and capable of withstanding certain environmental conditions. The construction can incorporate advanced materials such as reinforced polymers or composite materials that offer enhanced resistance to environmental stressors while maintaining a lightweight profile for easy transport and deployment. The rigid main body can also incorporate insulating materials including polystyrene, neoprene, acrylic, acrylonitrile butadiene styrene, nylon, polybenzimidazole, polyvinyl chloride, and/or fluoropolymers. A skilled artisan can select suitable materials for the rigid main body of the emergency locator device within the scope of the present disclosure.

One of ordinary skill in the art can also select one or more specific coating and treatment to further enhance the environmental resistance and functionality of the main body. The coatings or treatments can include conductive oxide coatings such as indium tin oxide and/or antimony tin oxide to enhance electromagnetic performance and signal transmission capabilities. Additional coating options can include polymeric materials such as PET, polyethylene, polypropylene, acetates, and nitrocellulose. Furthermore, the main body can be coated with materials capable of changing color or pattern to match the surrounding environment, enhancing concealment capabilities. Additionally, the dual-function emergency locator device can be configured to float in water under a weight of the device and/or float with the weight of the device and a selected payload weight.

The main body can include a multi-layer structure where each layer contributes to specific signal management capabilities. The layers can be configured with different materials to provide both signal control and physical protection. For example, one layer can include radio frequency reflective material while another layer incorporates radio frequency absorbing material, allowing for strategic control of electromagnetic signals. The multi-layer structure can be arranged such that a material that militates against radio frequencies from passing through (reflecting material) can be positioned on one layer, while a different layer enhances transmission. This configuration allows the device to be oriented with the reflecting material either outwardly or inwardly facing depending on operational requirements. When oriented with the reflecting material outward, the device can effectively manage external signals, while an inward orientation can help conceal the passive reflection capabilities of the device, if desired. The layers can also be arranged in specific combinations to optimize signal management. For example, one configuration can include the radio frequency reflection element followed by an absorbing material and then a reflecting material. In this arrangement, when the radio frequency reflection element faces outward, the absorbing material can function to further distinguish the reflected radio frequency. Alternatively, when the radio frequency reflection element faces inward, the reflecting material can be positioned outwardly facing to conceal the passive reflection capabilities of the device.

The dual-function emergency locator device can be configured as a wearable device. The device can be incorporated into and/or coupled to clothing or equipment as part of a patch, badge, emblem, panel, tag, or pocket to conceal presence of the device while protecting the device and facilitating maintaining it in proximity to a user. The device can be implemented as a demountable textile unit having externally positioned hook-and-loop structures. The components can be stacked within a hook and loop patch separated by foam spacers, or alternatively, the same constituent components can be contained within an emblem or patch. Being contained within two layers of hook and loop, the device can be worn on body by the operator. In military applications, the device can be worn on uniform shoulder patches or elsewhere on equipment. In commercial applications, the device can be worn on a backpack or article of clothing that contains hook and loop.

The device can be incorporated into a flexible receptacle with an open end that can open to allow access to the device positioned therein. The receptacle can include various attachment mechanisms including demountable fasteners such as hook-and-loop fasteners, buttons, clips, snap fasteners, snap-fittings, bolts, latches, and magnets. Non-demountable fasteners can also be utilized, including crimps, glue, adhesive, cabling, screws, and nails. The device can be flexible to allow out-of-plane bending when worn. The components can be positioned within or on a textile that includes polymeric materials such as plastics and rubbers, as well as natural materials like leather and cotton. The textile can include a compartment such as a pouch, pocket, or sack to hold the device, or alternatively, can include a panel to which the device can be affixed. The device can be sewn into a pouch to hold the components and peripheral electronics, such as a battery or transmit button. This configuration allows the device to be worn on the body by the operator while maintaining its full functionality and protecting the internal components.

The main body can include a lid that can be configured to removably cover a generally hollow interior. The lid can be selectively coupled to the main body with either the top surface or the bottom surface of the lid facing the generally hollow interior. The lid can include radio frequency (RF) elements that can be implemented in any portion of the device by means of 3D printing or printed/digitally cut inserts/adhesive additions. In the certain embodiments, the RF elements can be 3D printed into the lid of the device. When the surface containing the passive radio signaling component and the active radio signaling component faces the generally hollow interior of the main body, the passive and active radio signaling components can be shielded from reflecting, receiving, and transmitting radio waves to make it more difficult for adversarial forces to detect the device when not in use. In certain embodiments, where the lid with RF elements faces into the electronics enclosure, dipoles can be attached to a coaxial cable by means of RF coaxial connectors.

The main body can also include a payload compartment that can be configured as a drawer. The drawer can carry articles such as an escape and evasion kit in military applications as well as medical or survival articles in military or commercial applications. Such articles can include a lock pick, knife, compass, key, bandage, alcohol wipe, needle, thread, matches, flint and steel, identification, money etc. The payload compartment can alternatively be configured as a drop out container to maximize payload capacity. The payload compartment can also be made to be a hinged compartment. In all configurations, the payload compartment can be made to be dust and watertight to protect stored items from environmental damage.

The main body can include an electronics compartment with PCB standoffs and the payload compartment can include a drawer lock. The electronics compartment can be configured to house a printed circuit board that can make an electrical connection with antenna elements when screwed into the standoffs. This can facilitate a covert antenna attachment such that unknowing parties would not know there was a transmitting antenna present even if they opened the electronics housing.

A temperature-controlled section of the hollow interior be provided within the payload compartment to allow for the storage of temperature-sensitive items, such as medical supplies, for example, that may need to be kept at specific temperatures to remain effective. An integrated cooling/heating system may be provided within the main body and/or the temperature-controlled section to mitigate against overheating of the active radio signaling components during extended operation. The integrated cooling system may be important for maintaining the integrity and functionality of the dual-function emergency locator device in prolonged use scenarios. It should be understood that the integrated cooling/heating system may also be used to maintain a desired temperature within the temperature-controlled section within the hollow interior.

The passive components and the active components can be disposed on or in the main body in multiple configurations. In certain embodiments, the components can be embedded within the lid so they are not readily detected by visual inspection. The lid can be selectively coupled to the main body with either the top surface or bottom surface facing the generally hollow interior. The lid can include a breakaway feature that disables functionality when forcibly detached, similar to how the coaxial cable can be configured with a breakaway feature that disables the antenna function when forcibly detached.

In certain embodiments, the passive component can be positioned proximate to a first side of the backplane while the active component can be positioned proximate to a second side of the backplane opposite the passive component. The components can be positioned relative to spacers to reduce electromagnetic interference with nearby components. Alternatively, both the passive component and active component can be positioned on the same side of the backplane. This arrangement can allow both components to be oriented in the same direction, reducing the need to reorient the device when switching between passive and active signaling.

The passive components and the active components can be embedded completely into the main body such that when a custom printed circuit board is screwed into the standoffs, it can make an electrical connection with the antenna elements. This can facilitate a covert antenna attachment such that unknowing parties would not know there was a transmitting antenna present even if they opened the electronics housing.

The passive components and the active components can be inlaid within recessed portions of the main body to be flush with the surface while maintaining functionality. The passive components and the active components elements can also be implemented in any portion of the device by means of 3D printing or printed/digitally cut inserts/adhesive additions that can be flush-mounted within the main body.

The main body of the dual-function emergency locator device can include user interface elements that allow for the activation of the active radio signaling component. A quick-release mechanism can be included in the main body which may facilitate the rapid deployment or detachment of the active and passive radio signaling components as required.

A system for emergency location and communication can include the dual-function emergency locator device. The system can be configured to enhance the effectiveness of search and rescue operations by providing precise location data and reliable communication links through both active and passive signaling capabilities. A remote receiver within the system can be capable of distinguishing between signals reflected by the frequency selective surface and signals transmitted by the dipole antenna. This capability can facilitate more accurate determination of the location and operational status of the dual-function emergency locator device. The system can utilize both the passive reflection capabilities of the meta surface and active transmission capabilities of the dipole antenna to provide redundant location determination methods.

A processing unit within the system can be configured to decrypt signals received from the dual-function emergency locator device. This security feature can ensure that sensitive information transmitted by the device remains confidential and accessible only to authorized personnel. Additionally, the processing unit can be configured to utilize the signals to determine position, navigation, and timing (PNT) of the device, even in GPS-denied or heavily monitored environments. The processing unit within the system can include software configured to provide real-time updates of the location of the dual-function emergency locator device. This feature can ensure that users have up-to-date information, which can be important for effective decision-making in emergency situations. The software can be configured to process both active emergency signals and passive reflected signals to determine the location of the device.

The system can include a database that stores historical data related to the signals received from the dual-function emergency locator device. This data can be used to analyze patterns, predict behaviors, and improve the overall effectiveness of the device in future operations. Additionally, the signals can be associated with specific assets and/or personnel allowing for the identification of the user and/or asset activating the device. The system can store multiple signal patterns to enable positive identification of different individuals or assets.

A communication network within the system can facilitate the transmission of data between the remote receiver and the processing unit. This network can help ensure that information flows smoothly and efficiently, enabling real-time updates and rapid response to emerging situations. The system can be integrated with existing military networks that enable aircraft, ships, vehicles, and dismounted persons to exchange tactical information in near real time.

The remote receiver within the system can include a directional antenna. This antenna can enhance the detection of signals from the dual-function emergency locator device, improving the accuracy and reliability of the location data obtained. The system can be configured to operate with various searching assets and can be designed to function in any desired frequency band depending on the searching asset.

The system can be configured to operate effectively in GPS-denied environments where conventional GPS signals are unavailable or unreliable. This capability can be important in congested and contested spectrum spaces, whether that space is GPS denied or heavily monitored by adversaries. The system can provide reactive low Probability of Intercept/Detection (LPI/LPE) capabilities while maintaining reliable communication. Additionally, the system can be integrated into search and rescue operation platforms, allowing it to be part of a coordinated effort to locate and assist individuals in distress, enhancing the overall effectiveness of rescue operations.

In operation, the dual-function emergency locator device can be utilized in both active and passive modes to enhance location and identification capabilities. When passive operation is desired, the frequency selective surface can be oriented outward to reflect specific radio frequencies from search assets. The FSS can be tuned to provide positive identification in X-band frequencies, allowing detection by a wider variety of searching platforms without requiring power from the device. In active operation mode, the user can activate the dipole antenna through the user interface elements to transmit emergency signals. The antenna can be connected to emergency locator beacon embedded modules such as COSPAS-SARSAT 406 MHz PCB cards or other radio modules depending on mission requirements. The active transmission can provide direct communication capabilities while maintaining low probability of intercept/detection characteristics.

In military operations, the device can be particularly effective when an isolated soldier becomes separated or is taken captive. The inconspicuous design of the device, appearing as an ordinary equipment component, can allow it to remain undetected while continuing to provide location data through either passive reflection or active transmission. The payload compartment can be accessed to utilize survival equipment as needed.

In search and rescue scenarios, the system can operate by having remote transmitters send specific radio frequencies toward the last known location of the device. The FSS can passively reflect these signals, while the active component can simultaneously transmit emergency beacons. The remote receiver can distinguish between these signals, allowing the processing unit to determine precise location information even in GPS-denied environments.

During extended operations, the device can maintain functionality through its integrated cooling system, while the water-tight seals protect internal components and stored supplies from environmental damage. The user can selectively orient the lid to either expose or conceal the RF elements based on tactical requirements. In stealth situations, the RF elements can be oriented inward to prevent detection while maintaining readiness for rapid deployment when needed.

In commercial applications, such as for hikers or skiers, the device can be activated to transmit distress signals that authorities can use for triangulation. The passive FSS component can simultaneously enhance detection capabilities by reflecting signals from search aircraft or rescue assets. The modular payload compartment can be configured with appropriate survival supplies for the specific environment and activity.

Advantageously, the present technology provides a dual-function emergency locator device that operates both actively and passively, enhancing reliability and effectiveness across various environmental conditions. The integration of a frequency selective surface allows for passive detection without continuous power consumption or the risk of detection by adversarial entities, while the active components ensure robust communication capabilities when needed. Furthermore, the design the dual-function emergency locator device may be inconspicuous and easily integrated with personal gear or vehicles, supporting stealth operations and maintaining a low profile in sensitive situations. This multifunctional approach not only improves interoperability with digital communication networks but also provides a versatile solution adaptable to coordinated operations, significantly enhancing the utility and effectiveness of signaling devices in military, search and rescue, and personal safety applications.

### EXAMPLES

Example embodiments of the present technology are provided with reference to the several figures enclosed herewith.

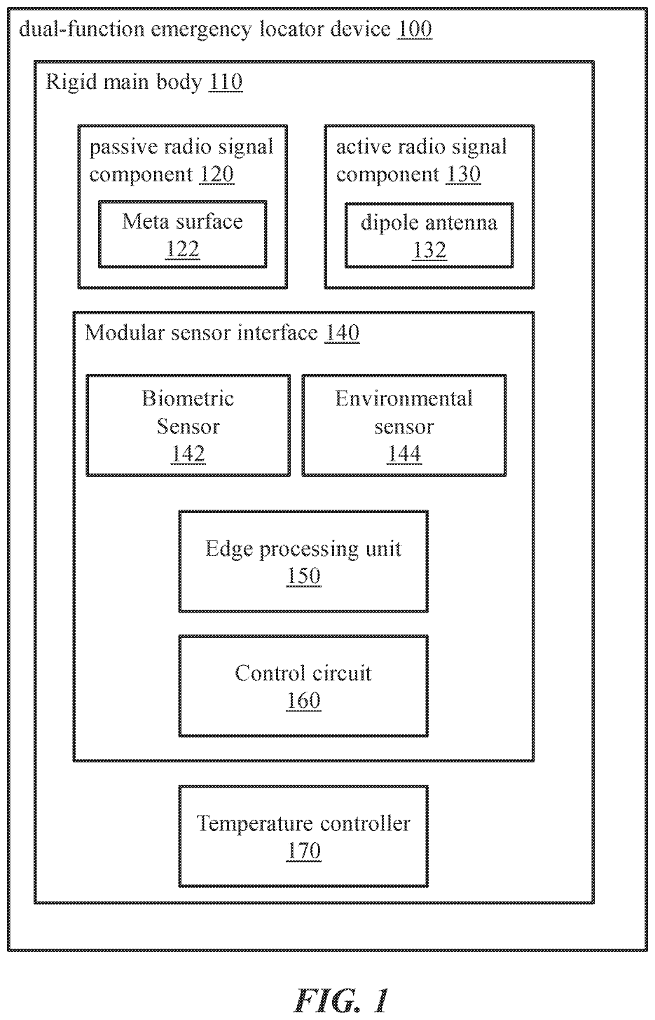

With reference to FIG. 1, a block diagram illustrating a dual-function emergency locator device 100 is shown. The device 100 can include a main body 110 that can house both a passive radio signaling component 120 and an active radio signaling component 130. The passive radio signaling component 120 can include a meta surface 122 that can be configured to provide passive of locating and identifying the device and operator. The meta surface 122 can include an array of RF frequency selective elements that can be polarization independent, allowing identification and location by a wider variety of assets. The active radio signaling component 130 can include a dipole antenna 132 that can be configured for transmitting and receiving radio signals. The dipole antenna 132 can be connected to emergency locator beacon embedded modules such as COSPAS-SARSAT PCB cards or other radio modules depending on mission requirements.

The device 100 can include a modular sensor interface 140 that can be configured to incorporate various sensors based on specific end-user requirements and operational needs. The modular sensor interface 140 can include a biometric sensor 142 configured to monitor physiological measurements such as heart rate and an environmental sensor 144 configured to detect environmental conditions such as barometric pressure, water pressure, chemical presence, and acoustic signatures. An edge processing unit 150 can be configured to process and analyze multiple data streams simultaneously from the various sensors. The processing unit 150 can utilize these data streams to determine when preset thresholds or specific criteria have been met. A control circuit 160 can be configured to execute code using multiple processing cores at different stages of execution and can independently execute two or more instruction threads to speed computational processes for functions like machine learning and artificial intelligence.

The device 100 can include a temperature controller 170 that can provide temperature control for both the internal components and a temperature-controlled section within the payload compartment. The temperature controller 170 can include an integrated cooling/heating system to mitigate against overheating of the active radio signaling components during extended operation while also maintaining desired temperatures for temperature-sensitive items such as medical supplies.

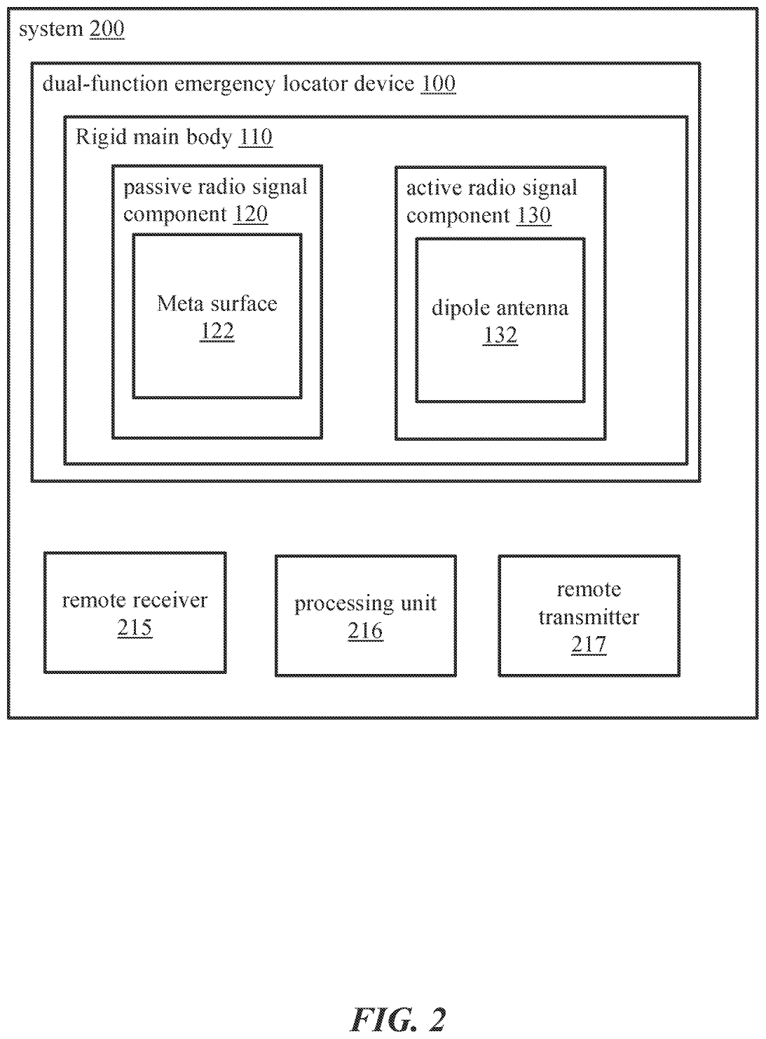

With reference to FIG. 2, a block diagram illustrating a system 200 for emergency location and communication is shown. The system 200 can include the dual-function emergency locator device 100 with its main body 110, passive radio signaling component 120 with meta surface 122, and active radio signaling component 130 with dipole antenna 132. The system 200 can also include a remote receiver 215 that can be capable of distinguishing between signals reflected by the meta surface 122 and signals transmitted by the dipole antenna 132. This capability can facilitate more accurate determination of the location and operational status of the device 100. The system 200 can include a processing unit 216 that can be configured to decrypt signals received from the device 100, ensuring sensitive information remains confidential and accessible only to authorized personnel. The system 200 can also include a remote transmitter 217 that can be configured to send radio signals to the device 100. The system 200 can utilize both the passive reflection capabilities of the meta surface 122 and active transmission capabilities of the dipole antenna 132 to provide redundant location determination methods, particularly valuable in GPS-denied environments where conventional signals may be unavailable or unreliable.

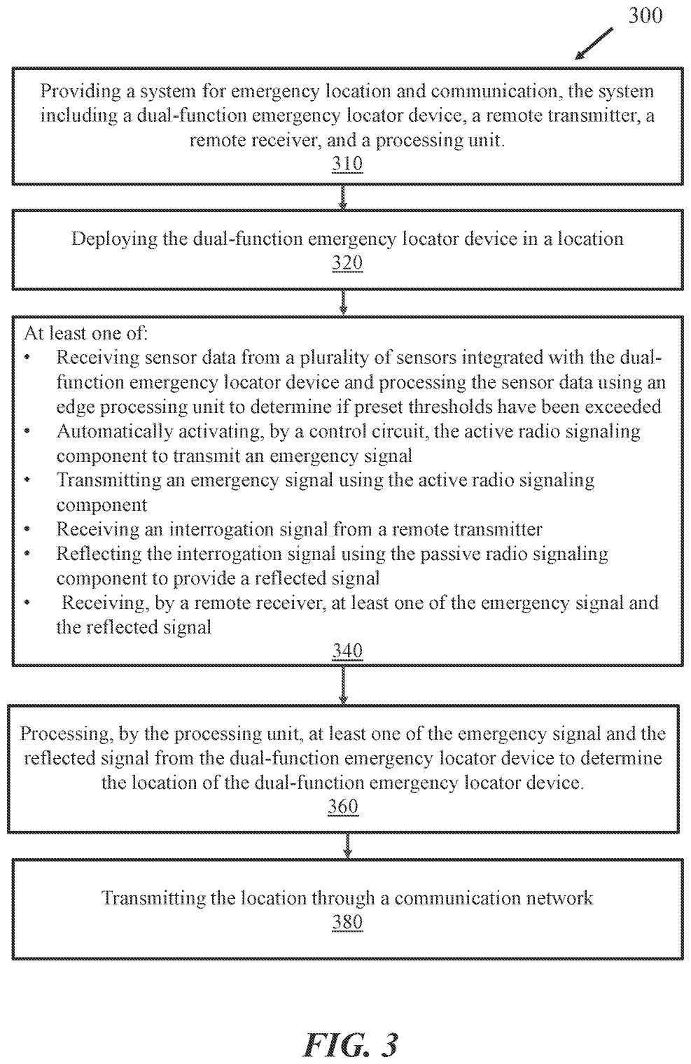

With reference to FIG. 3, a flowchart illustrating a method 300 for locating and communicating in emergency situations is shown. The method 300 can include a step 310 of providing a system for emergency location and communication that can include a dual-function emergency locator device 100 having a main body 110, a passive radio signaling component 120 with a meta surface 122 configured to passively reflect specific radio frequencies, and an active radio signaling component 130 with a dipole antenna 132 configured for transmitting and receiving radio signals.

The method 300 can include a step 320 of deploying the dual-function emergency locator device 100 in a location. The method 300 can include a step 340 of at least one of: receiving sensor data from a plurality of sensors integrated with the dual-function emergency locator device 100 and processing the sensor data using an edge processing unit 150 to determine if preset thresholds have been exceeded; automatically activating, by a control circuit 160, the active radio signaling component 130 to transmit an emergency signal; transmitting an emergency signal using the active radio signaling component 130; receiving an interrogation signal from a remote transmitter 217; reflecting the interrogation signal using the passive radio signaling component 120 to provide a reflected signal; and receiving, by a remote receiver 215, at least one of the emergency signal and the reflected signal.

The method 300 can include a step 360 of processing, by a processing unit 216, at least one of the emergency signal and the reflected signal from the dual-function emergency locator device 100 to determine the location and/or identity of the device 100. The processing unit 216 can be configured to decrypt the received signals to ensure sensitive information remains confidential and accessible only to authorized personnel.

The method 300 can include a step 380 of transmitting the location through a communication network. The method 300 can include storing data related to the signals in a database for analyzing patterns and predicting behaviors. The method 300 can include updating a user interface with real-time location information of the device 100. The method 300 can be implemented as part of a coordinated search and rescue operation or military operation to locate isolated personnel.

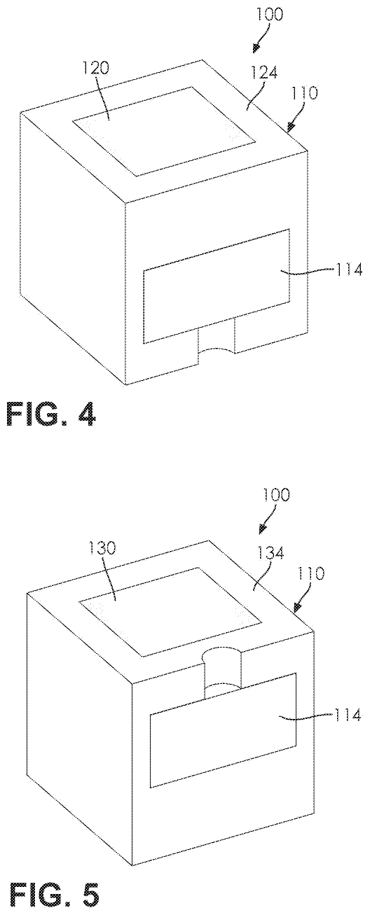

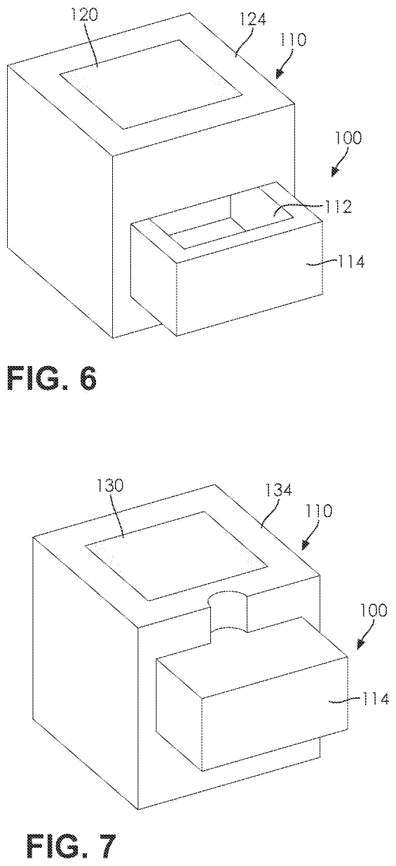

FIGS. 4-7 show various views of a dual-function emergency locator device 100 that can include a main body 110 configured in a cube-shaped structure. The passive radio signaling component 120 with can be disposed within a top surface 124 of the main body 110, while the active radio signaling component 130 can be disposed within a bottom surface 134 of the main body 110. The main body 110 can also include a payload compartment 112 that can be configured as a drawer 114. The drawer 114 can carry articles such as an escape and evasion kit in military applications as well as medical or survival articles in military or commercial applications. Such articles can include a lock pick, knife, compass, key, bandage, alcohol wipe, needle, thread, matches, flint and steel, identification, money etc. The payload compartment 112 can be made to be dust and watertight to protect stored items from environmental damage. The payload compartment can include a temperature-controlled section 170 that can allow for the storage of temperature-sensitive items such as medical supplies.

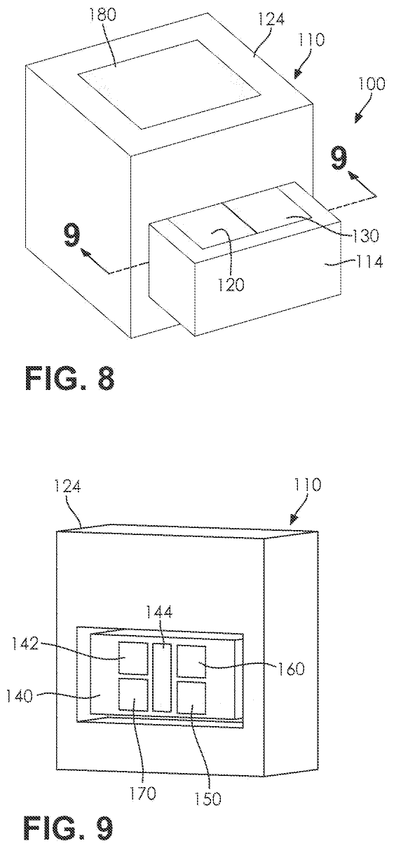

In another embodiment shown in FIG. 8, the passive radio signaling component 120 and active radio signaling component 130 can be disposed within the drawer 114 itself. This configuration can allow the passive radio signaling component 120 with meta surface 122 and active radio signaling component 130 with dipole antenna 132 to be concealed when the drawer 114 is closed while still maintaining their operational capabilities. In FIG. 8, the dual-function emergency locator device 100 can include a user interface element 180 that can allow for the activation of the active radio signaling component 130. The user interface element 180 can be designed to be user-friendly, helping individuals in distress to activate the device even under stressful conditions. The user interface element 180 can be positioned within the main body 110 along with the passive radio signaling component 120 with meta surface 122 and active radio signaling component 130 with dipole antenna 132. The user interface element 180 can be configured to send operation signals to the control circuit 160 to activate various functions of the device 100.

FIG. 9 presents a cross-sectional view revealing an embedded modular sensor interface 140 that can incorporate various sensors based on specific mission requirements. The modular sensor interface 140 can include a biometric sensor 142 that can be configured to monitor physiological measurements such as heart rate, body temperature, and other vital signs. An environmental sensor 144 can be configured to detect various environmental conditions including barometric pressure, water pressure, chemical presence, acoustic signatures, and other environmental parameters. The sensors 142, 144 can be integrated with the edge processing unit 150 and control circuit 160 to enable automated activation based on sensor readings exceeding preset thresholds. The temperature controller 170 can maintain optimal operating conditions for both the electronic components and any temperature-sensitive items stored in the payload compartment.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A dual-function emergency locator device comprising:
a main body;
a passive radio signaling component disposed in the main body and configured to passively reflect specific radio frequencies; and
an active radio signaling component disposed in the main body and including a dipole antenna configured for transmitting and receiving radio signals.

2. The dual-function emergency locator device of claim 1, wherein the passive radio signaling component includes a member selected from a group consisting of a Van Atta array, a reconfigurable intelligent surface, an electromagnetic skin configured to provide unique electromagnetic signatures.

3. The dual-function emergency locator device of claim 1, wherein the active radio signaling component further includes a member selected from a group consisting of a signal modulating component, an amplifier, a digital radio frequency memory (DRFM), a beam steering capability configured to provide a distinct and directed signal response, and combinations thereof.

4. The dual-function emergency locator device of claim 1, further including a sensor selected from a group consisting of a wearable biofeedback sensor, a barometric pressure sensor, a water pressure sensor, an acoustic sensor, a SIGINT sensor, an optical sensor, an environmental sensor, a chemical detection sensor, a location and targeting sensor, and combinations thereof.

5. The dual-function emergency locator device of claim 4, further comprising a control circuit configured to automatically activate the active radio signaling component when a sensor reading meets or exceeds a preset threshold, wherein the preset threshold includes a member selected from a group consisting of an environmental condition, a physiological measurement, a chemical detection threshold, a pressure variation, an acoustic signature, and combinations thereof.

6. The dual-function emergency locator device of claim 1, further comprising: an edge processing unit configured to process and analyze multiple data streams simultaneously from various sensor inputs, wherein the edge processing unit includes a processing core configured to execute code at different stages of execution for machine learning and artificial intelligence functions.

7. The dual-function emergency locator device of claim 1, further comprising: a communication interface configured to transmit one of a sensor reading and an automated alert.

8. The dual-function emergency locator device of claim 1, wherein the passive radio signaling component is tuned to operate within a predetermined frequency range.

9. The dual-function emergency locator device of claim 1, wherein the dipole antenna is connected to a coaxial cable for signal transmission.

10. The dual-function emergency locator device of claim 9, wherein the coaxial cable is configured with a breakaway feature that disables an antenna function when forcibly detached.

11. The dual-function emergency locator device of claim 1, further comprising a payload compartment integrated into the main body.

12. The dual-function emergency locator device of claim 11, wherein the payload compartment includes a water-tight seal.

13. The dual-function emergency locator device of claim 11, wherein the payload compartment is configured to be modular and allowing for at least one module to be selectively inserted.

14. The dual-function emergency locator device of claim 11, wherein the payload compartment includes a temperature-controlled section.

15. The dual-function emergency locator device of claim 1, wherein the main body includes a user interface element configured to activate the active radio signaling component.

16. The dual-function emergency locator device of claim 1, wherein the main body is configured to be attachable to personal gear or a vehicle.

17. The dual-function emergency locator device of claim 1, wherein the active radio signaling component and the passive radio signaling component are embedded within the main body.

18. The dual-function emergency locator device of claim 1, wherein the passive radio signaling component includes a Van Atta array, a reconfigurable intelligent surface, and an electromagnetic skin configured to provide unique electromagnetic signatures for enhanced location and identification capabilities, and wherein the active radio signaling component includes a signal modulating component, an amplifier, a digital radio frequency memory (DRFM), and a beam steering capability configured to provide a distinct and directed signal response, and further comprising a wearable biofeedback sensor, a barometric pressure sensor, a water pressure sensor, an acoustic sensor, a SIGINT sensor, an optical sensor, an environmental sensor, a chemical detection sensor, and a location and targeting sensor, and a control circuit configured to automatically activate the active radio signaling component when a sensor reading meets or exceeds a preset threshold, and an edge processing unit configured to process and analyze multiple data streams simultaneously from various sensor inputs, wherein the edge processing unit includes a processing core configured to execute code at different stages of execution for machine learning and artificial intelligence functions, and a communication interface configured to transmit one of a sensor reading and an automated alert, wherein the passive radio signaling component is tuned to operate within a predetermined frequency range, and wherein the dipole antenna is connected to a coaxial cable for signal transmission, wherein the coaxial cable is configured with a breakaway feature that disables an antenna function when forcibly detached, and further comprising a payload compartment integrated into the main body, wherein the payload compartment includes a water-tight seal and is configured to be modular and allowing for at least one module to be selectively inserted, and includes a temperature-controlled section, and wherein the main body includes a user interface element configured to activate the active radio signaling component and is configured to be attachable to personal gear or a vehicle, and wherein the active radio signaling component and the passive radio signaling component are embedded within the main body.

19. A system for emergency location and communication comprising:
a dual-function emergency locator device according to claim 1:
a remote receiver configured to detect signals transmitted by the active radio signaling component of the dual-function emergency locator device; and
a processing unit configured to analyze signals received from the dual-function emergency locator device and determine a location of the dual-function emergency locator device based on the signals.

20. A method for locating and communicating in emergency situations, the method comprising:
providing a dual-function emergency locator device including:
a main body;
a passive radio signaling component disposed in the main body and configured to passively reflect specific radio frequencies; and
an active radio signaling component disposed in the main body and including a dipole antenna configured for transmitting and receiving radio signals, deploying the dual-function emergency locator device in a location; and
at least one of:
receiving sensor data from a sensor integrated with the dual-function emergency locator device and processing the sensor data using an edge processing unit to determine if a preset threshold has been exceeded;
automatically activating, by a control circuit, the active radio signaling component to transmit an emergency signal;
transmitting an emergency signal using the active radio signaling component;
receiving an interrogation signal from a remote transmitter;
reflecting the interrogation signal using the passive radio signaling component to provide a reflected signal;
receiving, by a remote receiver, at least one of the emergency signal and the reflected signal;
processing, by a processing unit, at least one of the emergency signal and the reflected signal to:
determine a location of the dual-function emergency locator device,
identify the dual-function emergency locator device, and
store signal data in a database;
transmitting the location through a communication network.
